(19) United States
(12) Patent Application Publication
(10) Pub. No.: US 2023/0376979 A1
(43) Pub. Date: Nov. 23, 2023

(54) SALES SUPPORT DEVICE, SALES SUPPORT METHOD AND SALES SUPPORT PROGRAM

(71) Applicant: NIPPON TELEGRAPH AND TELEPHONE CORPORATION, Tokyo (JP)

(72) Inventors: Sun Yeong KIM, Tokyo (JP); Kazuaki OBANA, Tokyo (JP); Miyuki IMADA, Tokyo (JP)

(73) Assignee: NIPPON TELEGRAPH AND TELEPHONE CORPORATION, Tokyo (JP)

(21) Appl. No.: 18/030,273

(22) PCT Filed: Oct. 5, 2021
(86) PCT No.: PCT/JP2021/036804

§ 371 Date: Apr. 5, 2023

(30) Foreign Application Priority Data
Oct. 7, 2020 (WO) PCT/JP2020/037997

(51) Int. Cl. G06Q 30/0202

(52) U.S. Cl. CPC G06Q 30/0202

(57) ABSTRACT

A business support device acquires at least business information including order reception/loss information relating to each commercial material for a company that is a business target of the commercial material, area information of a company, a business type of the company, and a company scale of the company, generates data used for prediction of an order reception score for each company and for each commercial material, predicts the order reception score for each commercial material and for each company using the generated data, and displays the predicted order reception score.

### TECHNICAL FIELD

The present invention relates to a business support device, a business support method, and a business support program.

### BACKGROUND ART

In order to perform business activities, a method of adaptively changing a customer tracking scheme according to an order reception accuracy of a commercial material, that is, according to an order reception rate of the commercial material, is generally performed. However, because information on the order reception rate of a commercial material according to business activity tends to easily accumulate with an individual in charge of business who performs the business activity, and prediction of the order reception rate of a commercial material is often based on the subjectivity of the person in charge of business who performs the business activity, it is difficult for another person to objectively evaluate the order reception rate of the commercial material.

On the other hand, Non Patent Literature 1 discloses a product that predicts an order rate for each case from accumulated business information by using artificial intelligence (AI).

### (NPL 1)

<URL: https://mazrica.com/press-release/p200817-insight/>

### SUMMARY OF INVENTION

### Technical Problem

However, because various types of information are included in business information accumulated in association with business activity, a range of the business information cannot be uniquely specified. For example, the business information includes properties of a company itself such as a company scale, the number of employees, and a task of which an organization is in charge, geographical properties, e.g., a location of the company or an area in which business is explored, properties related to a relationship with a person in charge of business who performs the business such as support correspondence related to a service under contract, temporal properties indicating occurrence times and change times of the properties described above, and the like.

On the other hand, machine learning may be used as a method of predicting the order reception rate of a commercial material, as illustrated in Non Patent Literature 1. When machine learning is used to predict the order reception rate of a commercial material according to business activities, what is selected as learning data from business information is important.

As items of business information used as learning data, i.e., attributes, increase, the number of dimensions of the learning data increases, and the number of parameters of a learning model (for example, a depth of a layer or the number of neurons in an intermediate layer in the case of a neural network, the number of decision trees or a maximum size of each tree in the case of boosting, or the like) increases. Accordingly, as the attributes used as the learning data increase, the amount of calculation required for learning increases, a time required for learning increases, and time is also required for prediction of the order reception rate using the learning model obtained by learning.

When an attribute not contributing to the prediction of the order reception rate or an attribute having a lower degree of contribution to the prediction of the order reception rate than other attributes is used for learning data, a likelihood of the predicted order reception rate becomes lower than when the prediction of the order reception rate is performed by using a learning model obtained by learning data not including the attribute because the attribute becomes noise.

Therefore, a business support device, a business support method, and a business support program capable of securing a likelihood of a predicted order reception rate while preventing a calculation amount required for learning of a learning model for predicting an order reception rate and a calculation amount required for prediction of the order reception rate from increasing, as compared with a case in which an order reception rate is predicted from accumulated business information including attributes that do not contribute to the prediction of the order reception rate, are disclosed.

### Solution to Problem

A first aspect of the present disclosure is a business support device comprising:
a data generation unit configured to acquire business information including at least order reception/loss information relating to business activity for each commercial material with respect to a company, which is a business target of a plurality of commercial materials configured of products or services, information on an area in which the company is located, a business type of the company, and a company scale of the company, and generate data used for prediction of an order reception score indicating an order reception likelihood for each company and each commercial material; a prediction creation unit configured to predict the order reception score for each company and for each commercial material by using the data generated by the data generation unit; and a prediction result display unit configured to display the order reception score predicted by the prediction creation unit.

A second aspect of the present disclosure is a business support method including: acquiring business information including at least order reception/loss information relating to business activity for each commercial material with respect to a company, which is a business target of a plurality of commercial materials configured of products or services, information on an area in which the company is located, a business type of the company, and a company scale of the company, and generating data used for prediction of an order reception score indicating an order reception likelihood for each company and each commercial material; predicting the order reception score for each company and for each commercial material by using the generated data; and displaying the predicted order reception score.

A third aspect of the present disclosure is a business support program for causing a computer to execute processing of: acquiring business information including at least order reception/loss information relating to business activity for each commercial material with respect to a company, which is a business target of a plurality of commercial materials configured of products or services, information on an area in which the company is located, a business type of the company, and a company scale of the company, and generating data used for prediction of an order reception score indicating an order reception likelihood for each company and each commercial material; predicting the order reception score for each company and for each commercial material by using the generated data; and displaying the predicted order reception score.

### Advantageous Effects of Invention

According to the business support device, the business support method, and the business support program of the present disclosure, there is an effect that it is possible to secure a likelihood of a predicted order reception rate while preventing a calculation amount required for learning of a learning model for predicting an order reception rate and a calculation amount required for prediction of the order reception rate from increasing, as compared with a case in which an order reception rate is predicted from accumulated business information including attributes that do not contribute to the prediction of the order reception rate.

### BRIEF DESCRIPTION OF DRAWINGS

FIG. 1 is a diagram illustrating a functional configuration example of a business support device.

FIG. 2 is a diagram illustrating an example of specification information.

FIG. 3 is a diagram illustrating an example of settlement information.

FIG. 4 is a diagram illustrating an example of a business activity history.

FIG. 5 is a diagram illustrating an example of a proposal history.

FIG. 6 is a diagram illustrating an example of commercial material definition information.

FIG. 7 is a diagram illustrating an example of three-dimensional tensor information.

FIG. 8 is a diagram illustrating an example of pattern information.

FIG. 9 is a diagram illustrating an example of evaluation results using AUC.

FIG. 10 is a block diagram illustrating a hardware configuration example of the business support device.

FIG. 11 is a flowchart illustrating an example of a flow of learning processing by a discrimination analysis model.

FIG. 12 is a flowchart illustrating an example of processing for predicting an order reception score.

FIG. 13 illustrates an example of a list of order reception scores.

FIG. 14 is a diagram illustrating an example of a targeting list generation unit.

FIG. 15 is a diagram illustrating an example of an SHAP figure.

FIG. 16 illustrates an example of a small model using a single decision tree.

FIG. 17 is an example of a distribution diagram illustrating a degree of contribution of each attribute to an order reception score.

FIG. 18 is a diagram illustrating an example of a visit route.

FIG. 19 is a diagram illustrating a functional configuration example of the business support device according to the first embodiment.

FIG. 20 is a diagram illustrating an example of a degree-of-similarity management unit.

FIG. 21 is a view illustrating a functional configuration example of a business support device according to Embodiment 2 of the present invention.

FIG. 22 is a diagram illustrating an example of evaluation results of learning and prediction using LightGBM.

FIG. 23 is a graph showing an example of an order reception rate by order reception score in a “commercial material 26.”

FIG. 24 is a diagram illustrating an example of an AUC.

### DESCRIPTION OF EMBODIMENTS

Hereinafter, an embodiment of a business support device 1 of the present disclosure will be described with reference to the drawings. The same components and the same processing are denoted by the same reference signs throughout the drawings, and redundant description is omitted.

Further, in the present disclosure, there is no restriction on content of kinds of commercial materials that are business targets, and the commercial materials include provision of a service configured of an intangible service such as telephone support for explaining how to use a product in addition to a product having some shape. That is, “commercial material” is a term representing a tangible product or an intangible service. Hereinafter, an example in which a network-related device including a business phone or a private branch exchanger (PBX), and a network-related service, which is a service attached to the network-related device, are handled as commercial materials will be described.

### First Embodiment

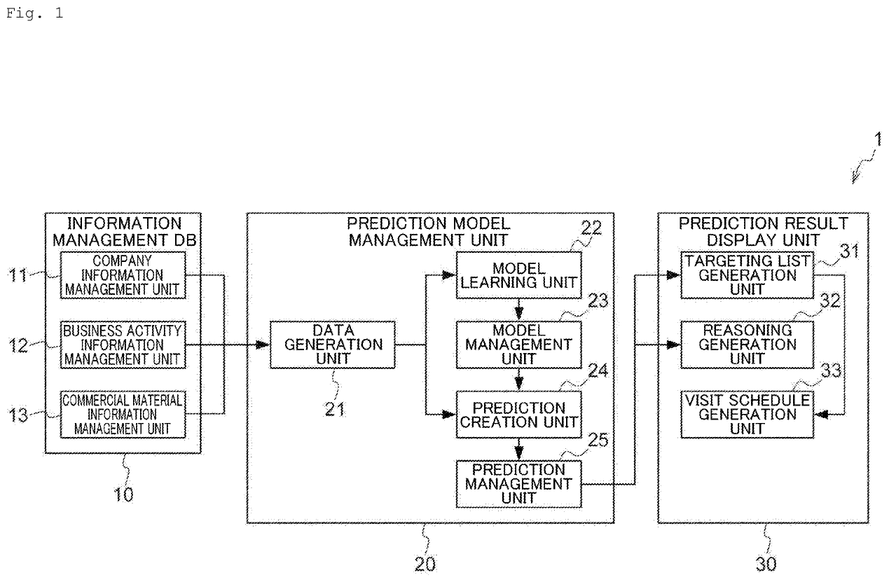

FIG. 1 is a diagram illustrating a functional configuration example of a business support device 1. The business support device 1 includes respective functional units such as the information management DB 10, a prediction model management unit 20, and a prediction result display unit 30.

The information management DB 10 is a database (DB) in which business information according to business activity of respective persons in charge of business is stored. The information management DB 10 is configured of a company information management unit 11, a business activity information management unit 12, and a commercial material information management unit 13.

The company information management unit 11 manages, for example, company information such as a company ID of a company that is a business target of a commercial material, a customer classification, capital money, a number of employees, a year of establishment, a score, a number of business offices, a foreign company flag, a business type, a total number of areas, a number of business offices in each area, and settlement information, for each attribute. In the company information, for example, the company ID of the company, the customer classification, the capital money, the number of employees, the number of business offices, and the settlement information represent a company scale. For example, the total number of areas and the number of business offices in each area represent area information on an area in which the company is located, such as the type of place in which the company exists.

The company information includes information meaningful in a change situation in a time series (hereinafter referred to as “variation information”), and information meaningful in the latest situation (hereinafter referred to as “fixed information”). The fixed information in the company information includes specification information 11A of the company, such as customer classification of a company, capital money, a number of employees, a year of establishment, a score, a number of business offices, a foreign company flag, a business type, a total number of areas, and a number of business offices in each area. The variation information in the company information includes, for example, settlement information 11B.

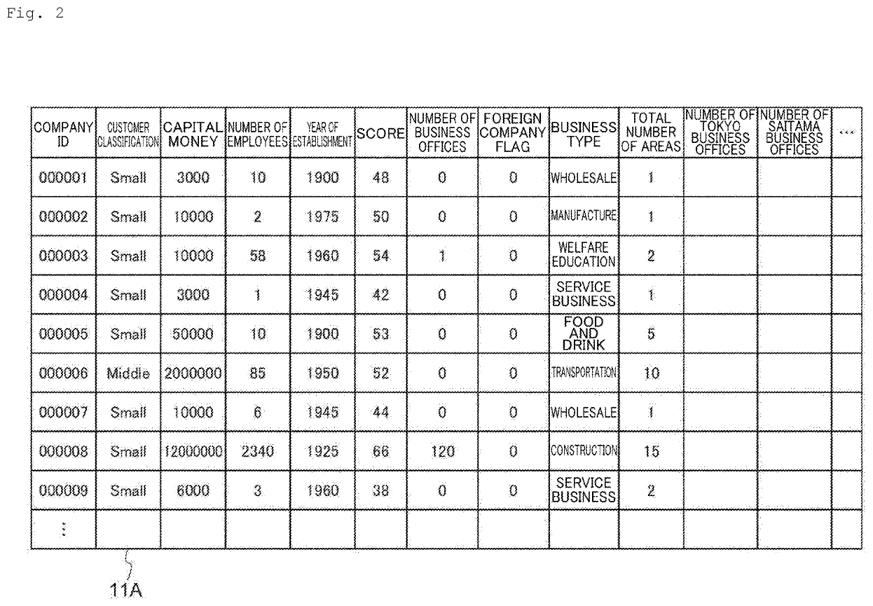

FIG. 2 illustrates an example of the specification information 11A of the company. As illustrated in FIG. 2, the latest situation regarding to the company is recorded in the specification information 11A for each attribute. In the specification information 11A, “score” is an attribute representing a comprehensive evaluation of the company by a numerical value, and “foreign company flag” is an attribute representing whether or not the company is a foreign company system. “Customer classification” is an attribute representing a kind of a large company (referred to as “Large”), a middle company (referred to as “Middle”), and a small company (referred to as “Small”). Further, the “area” represents, for example, an area of a local government unit, but may be a range extending over a plurality of local governments. The “total area number” is an attribute representing the number of areas in which a business office is located. The specification information 11A may include other information such as an address or a telephone number of a business office, for example.

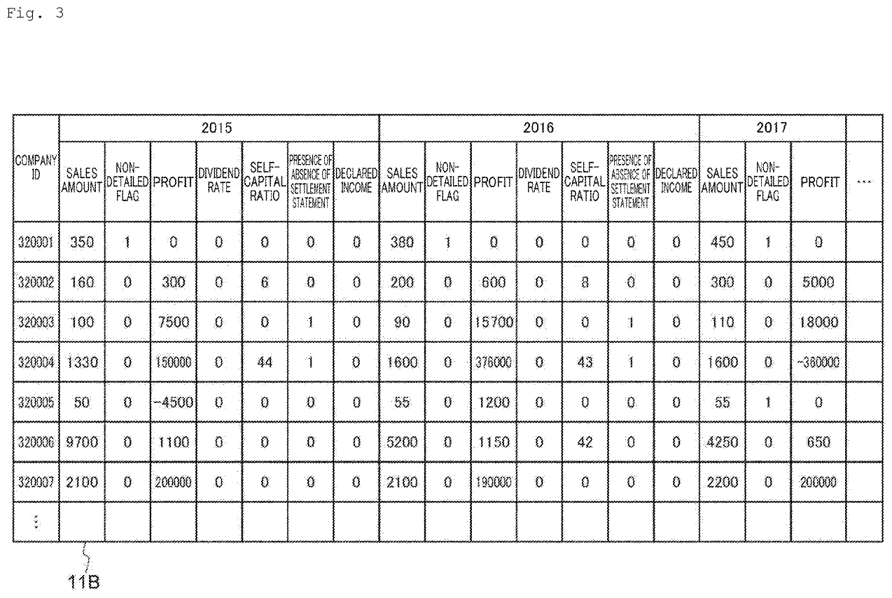

FIG. 3 is a diagram illustrating an example of the settlement information 11B. As illustrated in FIG. 3, in the settlement information 11B, attributes regarding past settlement are recorded in units of years for each company. The attributes regarding the settlement include, for example, a sales amount, an undetailed flag, a profit, a dividend rate, a self-capital ratio, presence/absence of a settlement statement, and a declared income application. The “undetailed flag” in the settlement information 11B is an attribute indicating whether or not detailed content other than the sales amount is published.

The specification information 11A and the settlement information 11B of the company can be acquired from a credit investigation institution, for example.

The business activity information management unit 12 manages a history of daily business activities by each person in charge of business. Specifically, the business activity information management unit 12 manages the history of business activities by dividing the history into a business activity history 12A for recording who has performed what kind of business activities, and a proposal history 12B for recording order reception/loss information of commercial materials for business activities.

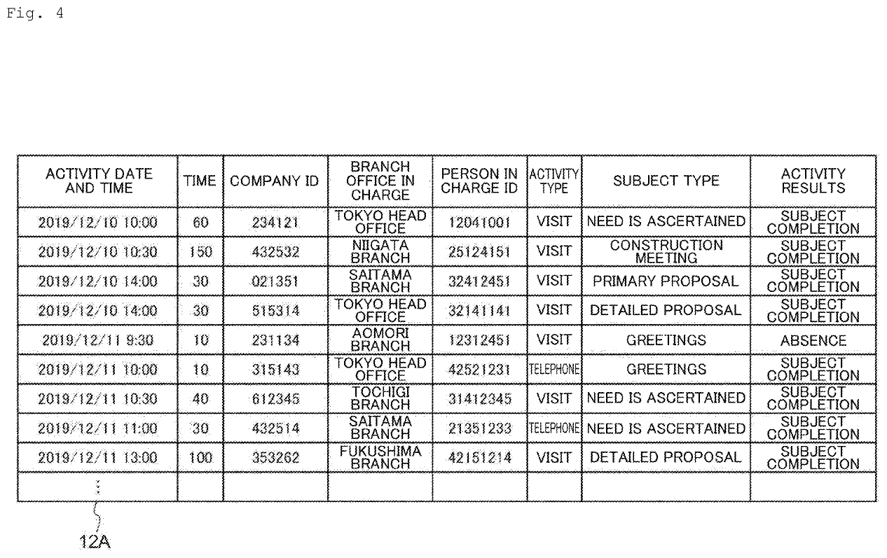

FIG. 4 is a diagram illustrating an example of the business activity history 12A. The business activity history 12A includes, for example, a business activity date and time, a time representing a period of business, a company ID of a business target company, a person in charge of a person in charge of business and branch office in charge, an activity type representing content of the activity, a subject type representing the purpose of business, and an activity result.

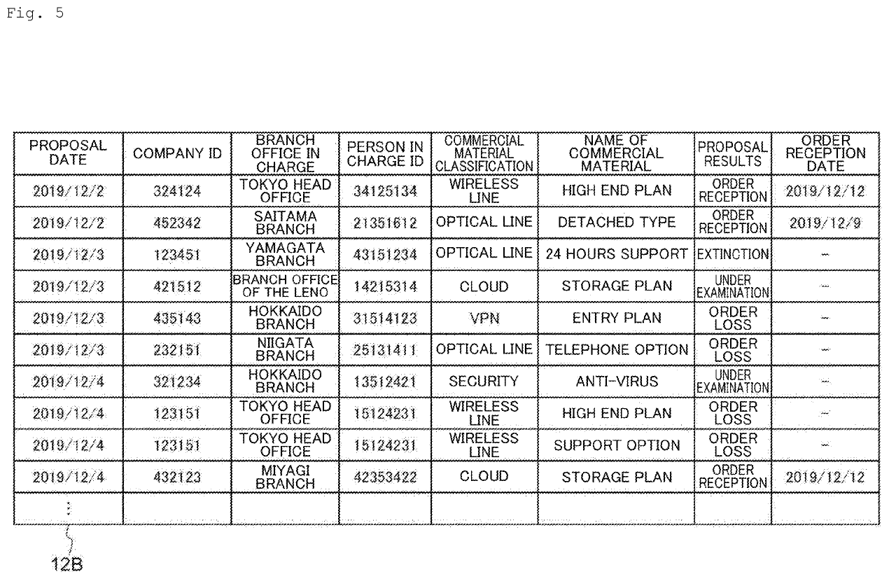

FIG. 5 is a diagram illustrating an example of the proposal history 12B. The proposal history 12B includes, for example, a proposal date when a commercial material is proposed, a company ID of a business target company, a person in charge of a person in charge of business and branch office in charge, a commercial material classification representing a category of a proposed product, a commercial material name of the proposed commercial material, a proposal result representing order reception/loss information of the proposed commercial material, and an order reception date when the order of the commercial material is received.

The commercial material information management unit 13 manages information on a plurality of commercial materials for business to the company (hereinafter referred to as “commercial material information”) as commercial material definition information 13A.

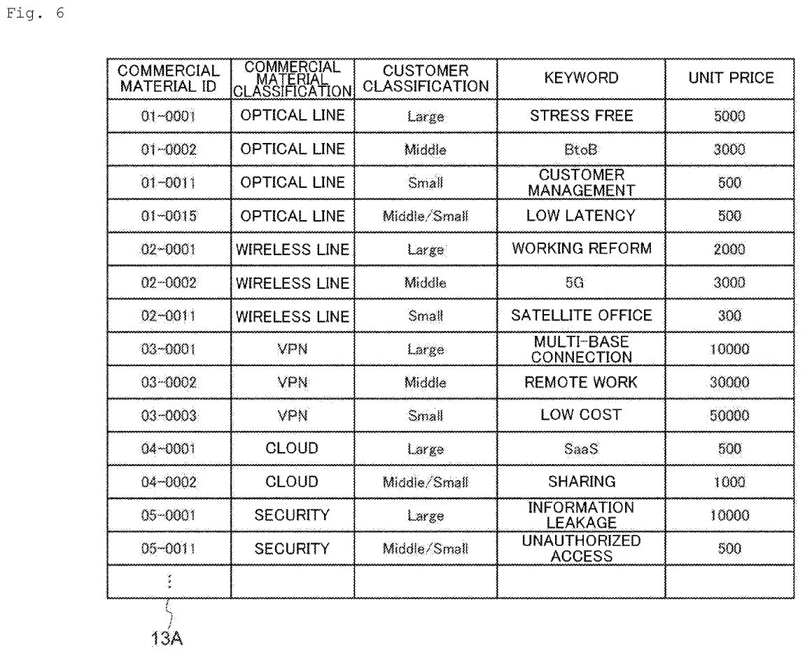

FIG. 6 illustrates an example of the commercial material definition information 13A. The commercial material definition information 13A includes, for example, a commercial material ID for identifying a commercial material, a commercial material classification representing a category of the commercial material, a customer classification that is a sales target of the commercial material (for example, whether it is for a large company or small or middle company), a keyword associated with the commercial material according to a specific business strategy such as “working reform” and “remote work”, and a unit price of the commercial material, for each commercial material.

The prediction model management unit 20 illustrated in FIG. 1 is a functional unit that acquires business information from the information management DB 10, and predicts an order reception rate indicating a likelihood of order reception of a commercial material according to a future business activity.

The prediction model management unit 20 includes a data generation unit 21, a model learning unit 22, a model management unit 23, a prediction creation unit 24, and a prediction management unit 25.

The data generation unit 21 acquires business information from the information management DB 10, and performs aggregation and preprocessing of the collected business information according to a prior definition to generate learning data and prediction data of a learning model for predicting an order reception rate of a commercial material. That is, the data generated by the data generation unit 21 includes learning data and prediction data.

The learning unit 22 uses the learning data generated by the learning data generation device 21 to construct a discrimination analysis model, which is an example of the learning model. That is, the learning data is a generic term of data used for construction of the discrimination analysis model in the model learning unit 22.

The model management unit 23 stores the discrimination analysis model constructed by the model learning unit 22 in the storage device, and acquires the discrimination analysis model from the storage device according to an instruction.

The prediction creation unit 24 acquires the designated discrimination analysis model from the storage device through the model management unit 23, and inputs prediction data generated by the data generation unit 21 to the discrimination analysis model to predict the order reception rate of the commercial material for each commercial material. Thereafter, the order reception rate of the commercial material is referred to as an “order reception score”. Information in which the order reception score predicted by the prediction creation unit 24 is associated with a combination of the company and the commercial material is called a “prediction result”.

The larger the value of the order reception score, the higher the order reception rate of the commercial material associated with the order reception score for the company associated with the order reception score.

The prediction management unit 25 stores a prediction result including the order reception score for each company and each commercial material predicted by the prediction creation unit 24 in the storage device, and acquires the prediction result from the storage device according to an instruction.

The prediction result display unit 30 is a functional unit that acquires a prediction result including the order reception score predicted by the prediction model management unit 20 through the prediction management unit 25, shaping the prediction result so as to be easy to use by a sales person, and displaying the prediction result to the sales person.

The prediction result display unit 30 includes a targeting list generation unit 31, an increasing generation unit 32, and a visit schedule generation unit 33.

The targeting list generation unit 31 generates a table in which companies are rearranged in order from companies having high order reception scores for each commercial material according to the prediction result of the prediction model management unit 20, and performs support for allowing the person in charge of business to determine which commercial material should be sold to which company.

The reasoning generation unit 32 visualizes the degree of contribution of each attribute to the order reception score, such as an attribute influencing the order reception score of the commercial material in each company, and a degree of the influence.

The visit schedule generation unit 33 generates a movement route for visiting companies efficiently from companies located in the same area, for example, companies having high order reception scores with respect to any commercial material, on the basis of the table generated by the targeting list generation unit 31.

Here, in order to the direction of the business strategy of the commercial material, each attribute of a commercial material name proposed to the company, a type of business of the business target company, and an area in which a business office of the business target company is located among the business information is acquired from the business information, and a non-negative tensor factorization (NTF) using each attribute is performed to analyze an order reception/loss situation of the commercial material.

The attribute used for the analysis of the order reception/loss situation of the commercial material described above is one example, and the order reception/loss situation of the commercial material may be analyzed by using settlement information 11B indicating the settlement state of the business target company and an attribute indicating the relationship between the person in charge of business and the company.

Specifically, at least one of, for example, a sales amount, a self-capital ratio, and a profit (preferably, a post-tax profit) in the settlement information 11B are used. Further, as attributes representing the relationship between the person in charge of business and the company, the number of existing contracts and contract periods acquired from the company by the person in charge of business, the business activity history 12A of the person in charge of business with respect to the company (for example, the number of visits, a time of visits, the number of calls, and calling time), a past support record of the person in charge of business with respect to the company (for example, the number of times of visit and call time), key person information representing a person linked to the person in charge of business in the company (for example, a business card exchange situation, and a position and authority of an opposite party who has performed business card exchange) are used. Among these, the number of existing contracts and contract periods acquired from the company by the person in charge of business, and the past support record of the person in charge of business with respect to the company have a stronger correlation with the order reception/loss situation of the commercial material than other attributes indicating the relationship between the person in charge of business and the company. Therefore, when the attribute indicating the relationship between the person in charge of business and the company is used for analysis of the order reception/loss situation of the commercial material, it is preferable to use any one of the number of existing contracts and contract periods acquired from the company by the person in charge of business and a past support record of the person in charge of business with respect to the company.

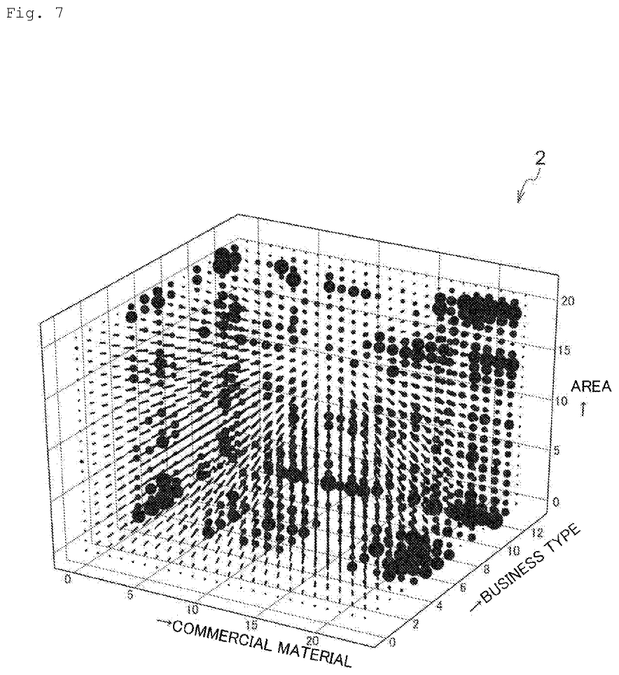

FIG. 7 is a diagram illustrating an example of three-dimensional tensor information 2 indicating an analysis result using NTF. A horizontal axis of the three-dimensional tensor information 2 represents a commercial material, a depth axis represents a business type, and a height axis represents an area. A size of a sphere at a coordinate point designated by a combination of the coordinate values of respective coordinates indicates the number of received orders for a combination of the commercial material, the business type, and the area corresponding to a specific coordinate value.

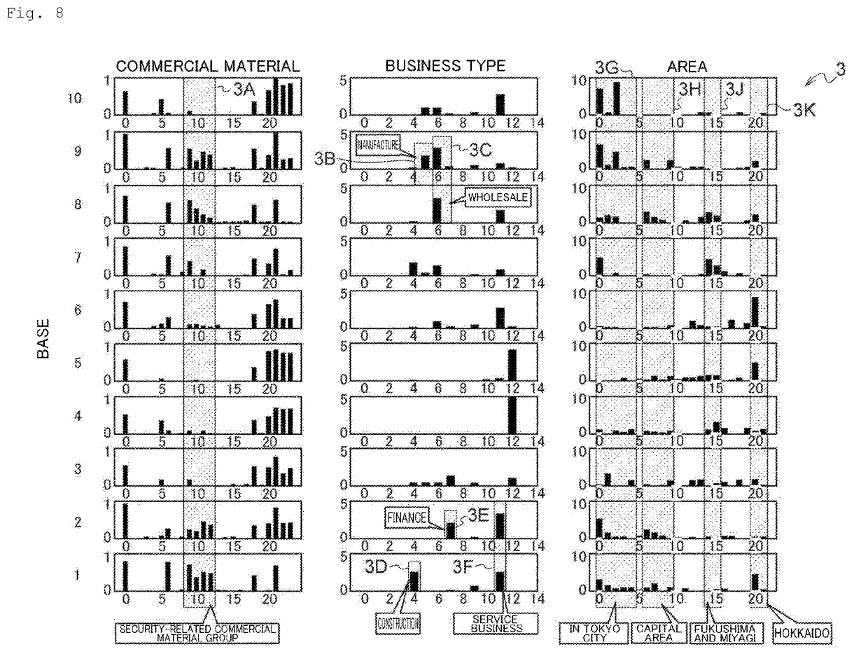

FIG. 8 is a diagram illustrating an example of pattern information 3 obtained by extracting ten kinds of order reception patterns from the three-dimensional tensor information 2 illustrated in FIG. 7 with a base number of 10.

In the pattern information 3 in which the respective commercial materials are arranged in FIG. 8, an area 3A represents a position of the commercial material in which the commercial material classification is included in “security”. In the pattern information 3 in which the respective types of business are arranged in FIG. 8, an area 3B, an area 3C, an area 3D, an area 3E, and an area 3F respectively represent positions of the business type corresponding to “manufacture”, “wholesale”, “construction”, “financial” and “service business”, respectively. In the pattern information 3 in which the respective areas are arranged in FIG. 8, an area 3G, an area 3H, an area 3J, and an area 3K represent positions of areas corresponding to “in Tokyo city”, “capital area”, “Fukushima and Miyagi”, and “Hokkaido”, respectively. Further, a height of a bar graph in the pattern information 3 indicates the number of received orders of the commercial material.

The following knowledge is obtained from the pattern information 3 illustrated in FIG. 8.

[Knowledge 1]

An order reception tendency of each commercial material is affected by the business types and areas. For example, for commercial materials whose commercial material classification is included in “security”, the number of received orders increases with pattern information 3 whose bases are represented by “1”, “2”, “8”, and “9”, as compared with other bases.

When the pattern information 3 of the business type in this case is considered, the order is not received by all the business types on average, but the number of received orders is larger than that of other business types in a specific business type, that is, “manufacture”, “wholesale”, “construction”, “financial”, and “service business”. When the pattern information 3 of the area in this case is considered, the order is not received in all areas on average, but the number of orders received in a specific area, that is, “in Tokyo city”, “capital area”, “Fukushima and Miyagi”, and “Hokkaido” is larger than that in other areas.

That is, it is shown that the number of received orders of the commercial material tends to be biased to a specific business type and a specific area.

It is also found that support-related service corresponding to, for example, failure of the commercial material purchased by the company is required to be highly reliable for the commercial material, and there is a demand for the company included in business type such as medical and financial industries in which a fatal problem is developed when the commercial material fails even in a relatively short period of time.

[Knowledge 2]

For commercial materials related to the network, for example, an order reception situation of base commercial materials represented by infrastructure facilities such as an optical line, a wireless line, and a virtual private network (VPN) affects the order reception of other commercial materials other than the base commercial materials. This is because the other commercial materials related to the network other than the base commercial materials strongly tend to be commercial materials for which purchase is examined on the assumption that the base commercial materials are contracted.

[Knowledge 3]

Among the commercial materials related to the network, commercial materials providing secure communication means such as VPN, for example, are demanded to companies having business offices in a plurality of areas. In this case, an area in which the business office is located and a range of which the business office is in charge affect the demand of the commercial material as compared with the number of business offices. Business information representing an area in which the business office is located and a range of which the business office is in charge includes, for example, the number of business offices and the total number of areas for each area.

[Knowledge 4]

Among the commercial materials related to the network, commercial materials providing services such as operation management of commercial materials or support of commercial materials are unnecessary services for a large company having a dedicated management department inside. Therefore, commercial materials providing services do not have the dedicated management department inside as compared with large companies, and there is a demand for small and middle companies such that employees having network knowledge perform maintenance of network-related devices in an idle time of original task. The business information representing the company scale includes, for example, capital money, the number of employees, the number of business offices, and settlement information, and the company scale can be estimated from these attributes. Further, as illustrated in FIG. 2, “customer classification” which is an attribute representing the company scale may be recorded in the specification information 11A.

From on the knowledge shown above, the business support device 1 predicts an order reception score of a product in a unit period using the discrimination analysis model in which the business type of the company, the area information of the area in which the business office of the company is located, the company scale, and the order reception/loss information for each product in the business information are input. When a discrimination analysis model is the discrimination analysis model for predicting the order reception score of the product using such inputs, there are no restrictions on the method of constructing the discrimination analysis model. For example, the discrimination analysis model may be constructed using various boostings such as logistic regression, support vector machine (SVM), a neural network, random forest, and xgBoost, light gradient boosting Machine (LightGBM), and CatBoost.

As the inputs of the discrimination analysis model, at least one of a past support record for the company and settlement information 11B of the company may be added in addition to the business type of the company, the area information of the area in which the business office of the company is located, the company scale, and the order reception/loss information for each commercial material.

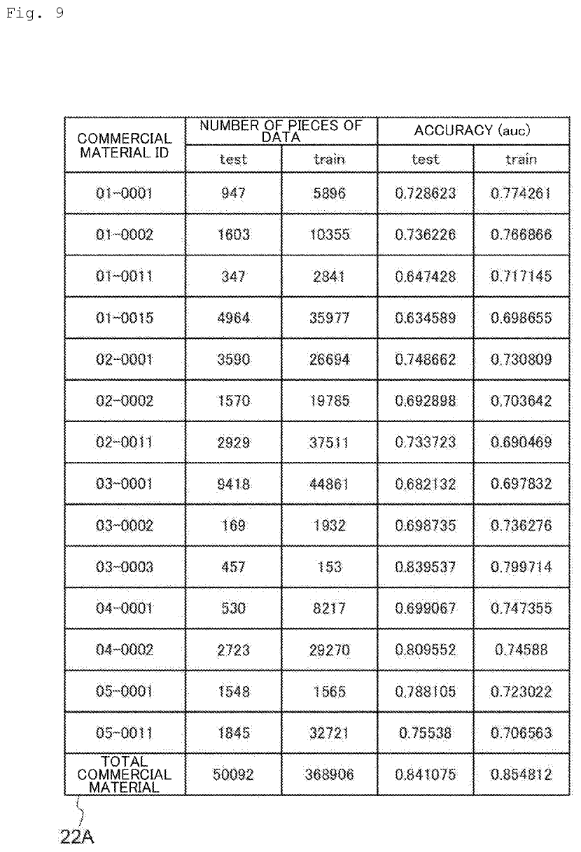

An example of the evaluation result 22A obtained by predicting order reception score for each company and each product using the discrimination analysis model constructed in this way, and evaluating the order of visits optimized by arranging the respective companies in order from the higher order of the order reception score for each commercial material in the visit schedule generation unit 33 by using an area under of the curve (AUC) is illustrated in FIG. 9.

In the evaluation result 22A illustrated in FIG. 9, the “train” in the data number column represents the number of pieces of learning data used for learning, and the “test” in the data number column represents the number of pieces of prediction data used for prediction. Further, the “train” in the accuracy column represents AUC for the learning data, and the “test” in the accuracy column represents AUC for the prediction data.

Business information for three years of a certain actual company is totaled for each half period, the discrimination analysis model is learned by learning data generated by using the business information for two years from the old one, the order reception score in a succeeding half period of the company is predicted by the discrimination analysis model by using the data of the remaining one year, and as a result, it has been found that an AUC of about 0.65 to 0.80 can be obtained in the learning data.

When AUC is equal to or larger than 0.7 with respect to the efficiency of visit, it can be considered that this is more effective than a case in which a visiting order of the company is determined without utilizing the business information, and thus, it can be seen that the prediction of the order reception score according to the discrimination analysis model is useful for business support.

The business support device 1 can be configured by using a computer 40.

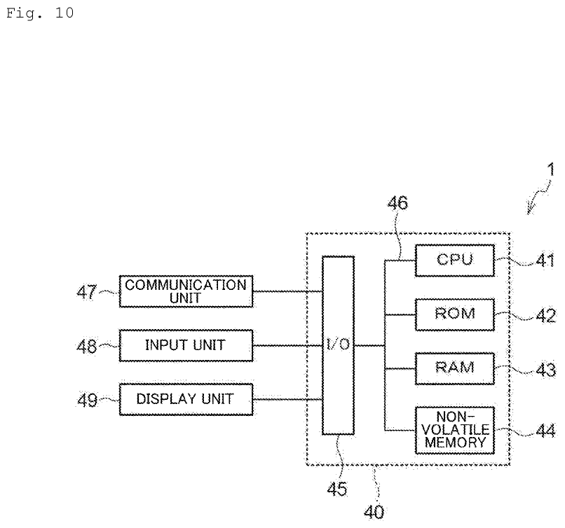

FIG. 10 is a block diagram illustrating a hardware configuration example of the business support device 1 using the computer 40. As illustrated in FIG. 10, the business support device 1 includes a central processing unit (CPU) 41, a read only memory (ROM) 42, a random access memory (RAM) 43, a non-volatile storage 44, and an input and output interface (I/F) 45. Then, the CPU 41, the ROM 42, the RAM 43, the non-volatile memory 44, and the I/O 45 are connected by a bus 46.

The CPU 41 is a central processing unit which executes various programs or controls each of the functional units. In other words, the CPU 41 reads a program from the ROM 42 or the non-volatile storage 44 and executes the program by using the RAM 43 as a work area. The CPU 41 performs control of each configuration of the business support device 1 illustrated in FIG. 1 and various arithmetic processing according to the program stored in the ROM 42 or the non-volatile memory 44. In the present embodiment, a business support program for predicting the order reception score of the commercial material for each company and for each commercial material by using business information and displaying the predicted order reception score is stored in the ROM 42 or the non-volatile memory 44.

The ROM 42 stores various programs and various types of data. The RAM 43 is a work area and temporarily stores a program or data. The non-volatile memory 44 is configured of a storage device such as a hard disk drive (HDD) or a solid state drive (SSD), and stores various programs including an operating system and various types of data.

For example, a communication unit 47, an input unit 48, and a display unit 49 are connected to the I/O 45.

The communication unit 47 is connected to, for example, a communication line such as the Internet and a local area network (LAN), and includes a communication protocol for performing data communication with an external device connected to the communication line. As the communication line, a wired line or a wireless line such as 4G, 5G, or Wi-Fi (registered trademark) is used.

The input unit 48 is a device that receives an instruction of the person in charge of business and notifies the CPU 41 of the instruction, and, for example, a button, a touch panel, a keyboard, and a mouse are used. When an instruction is received by voice, a microphone may be used as the input unit 48.

The display unit 49 is an example of a device that visually displays the information processed by the CPU 41, and for example, a liquid crystal display, an organic electro luminescence (EL) display, or a projector is used.

Next, an operation of the business support device 1 will be described.

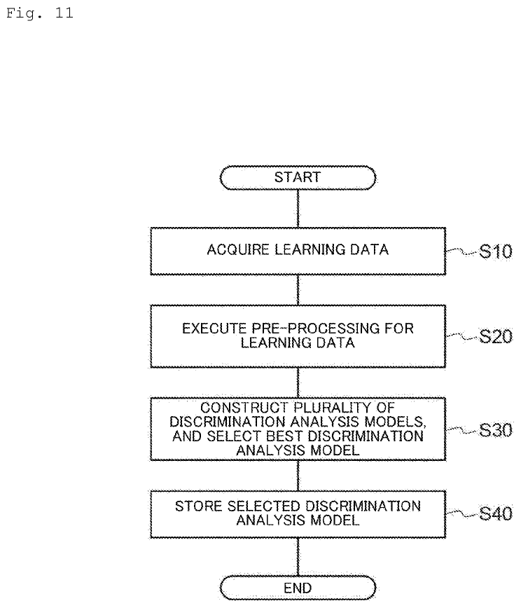

FIG. 11 is a flowchart illustrating a flow of learning processing by the business support device 1. The learning processing for the discrimination analysis model is performed by having the CPU 41 read the business support program from the ROM 42 or the non-volatile storage 44, expand the program to the RAM 43, and execute the program.

The CPU 41 executes the learning processing for the discrimination analysis model for each unit period such as a half year or one year or at an arbitrary timing instructed by the person in charge of business. Here, as an example, the CPU 41 executes the learning processing for the discrimination analysis model for each unit period.

In step S10, the CPU 41 acquires the business type of the company, area information of an area in which a business office of the company is located, and each attribute indicating the company scale recorded in the specification information 11A from the company information management unit 11. The CPU 41 acquires the order reception/loss information recorded in the proposal history 12B from the business activity information management unit 12, and acquires the commercial material information of the commercial material indicated by the order reception/loss information recorded in the commercial material definition information 13A from the commercial material information management unit 13.

Specifically, the CPU 41 acquires the order reception/loss information until latest execution of the learning processing of the discrimination analysis model from three years ago with reference to a predetermined period, for example, a time when learning processing of the discrimination analysis model is executed in the business information, the business type, the area information, the company scale, and the commercial material information as learning data from the information management DB 10.

In step S20, the CPU 41 executes preprocessing such as totalization processing or normalization for the learning data acquired in step S10. The totalization processing includes totalization processing in which a part of the learning data is verification data for cross verification because the totalization processing is used for cross verification (also referred to as “cross-validation”) of the discrimination analysis model. The preprocessing performed by the CPU 41 is defined in advance.

In step S30, the CPU 41 performs learning of the discrimination analysis model by using the learning data. “Training of the discrimination analysis model using learning data” means constructing the discrimination analysis model from the learning data. A learning method for the discrimination analysis model using the learning data is according to a known method of constructing the discrimination analysis model.

For example, in the case of learning the discrimination analysis model using a neural network, it is possible to learn the discrimination analysis model by repeating an input/output relationship in which the business type of the company, the area information, the company scale, and the commercial material information included in the learning data are input, and “1” is output when an order is received and “0” is output when an order is lost, by the number of pieces of learning data, on the basis of the order reception/loss information of the commercial material indicated by the commercial material information, and giving a result thereof to the neural network.

Thus, the CPU 41 constructs a plurality of discrimination analysis models according to each method by using a plurality of known methods for constructing discrimination analysis models.

Then, the CPU 41 selects one of the discrimination analysis models having the highest correct answer rate, that is, the best discrimination analysis model having the best prediction accuracy of the order reception score, from among the plurality of discrimination analysis models through cross verification, for example.

In step S40, the CPU 41 stores the discrimination analysis model selected in step S30 in the non-volatile memory 44. Thus, the learning processing for the discrimination analysis model illustrated in FIG. 11 ends.

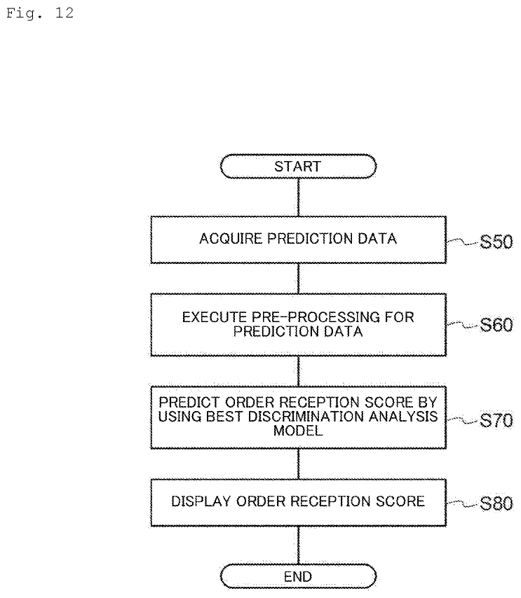

FIG. 12 is a flowchart illustrating an example of a flow in the processing for predicting the order reception score executed by the business support device 1 after the learning processing for the discrimination analysis model ends. The processing for predicting the order reception score is performed by the CPU 41 reading the business support program from the ROM 42 or the non-volatile storage 44, expand the program to the RAM 43, and execute the program.

Because the discrimination analysis model is updated for each unit period by the learning processing for the discrimination analysis model, the CPU 41 preferably executes the learning processing for the discrimination analysis model and the processing for predicting the order reception score as a series of processing. Naturally, the CPU 41 may execute the processing for predicting the order reception score separately from the learning processing for the discrimination analysis model at an arbitrary timing instructed by the person in charge of business.

In step S50, the CPU 41 acquires a business type, area information, company scale, and commercial material information for past one year based on a predetermined period, for example, a time when the processing for predicting the order reception score is executed in the business information, from the information management DB 10 as prediction data.

In step S60, the CPU 41 executes preprocessing such as totalization processing or normalization on the prediction data acquired in step S50.

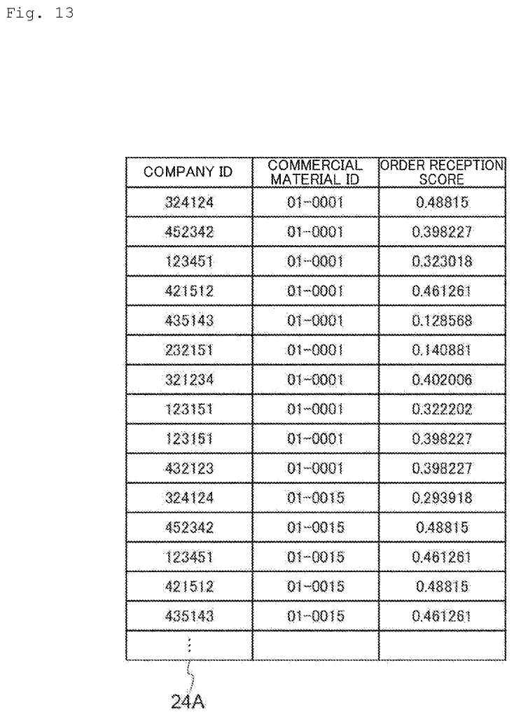

In step S70, the CPU 41 acquires the best discrimination analysis model stored in the non-volatile memory 44 in step S40 in the learning processing for the discrimination analysis model illustrated in FIG. 11. Then, the CPU 41 inputs each piece of prediction data acquired in step S50 to the acquired discrimination analysis model and predicts the order reception score for each company and each commercial material. FIG. 13 is a diagram illustrating an example of a list 24A of order reception scores predicted by the CPU 41. The value of the order reception score is normalized so as to be, for example, 0 or more and 1 or less, and this indicates that the order reception rate of the commercial material corresponding to the commercial material ID is higher in the company corresponding to the company ID as the value comes closer to “1”.

In step S80, the CPU 41 displays the prediction result of the order reception score obtained in step S70 through the display unit 49. Thus, the processing for predicting the order reception score illustrated in FIG. 12 ends.

The learning processing for the discrimination analysis model illustrated in FIG. 11 and the processing for predicting the order reception score illustrated in FIG. 12 are referred to as “business support processing”.

The CPU 41 predicts the order reception score of the commercial material for each company and for each commercial material by using the best discrimination analysis model having the best prediction accuracy of the order reception score selected from the plurality of discrimination analysis models, but the method of predicting the order reception score of the commercial material is not limited to this method.

For example, the CPU 41 may select at least two or more discrimination analysis models among the plurality of discrimination analysis models constructed in step S30 of the learning processing for the discrimination analysis model illustrated in FIG. 11, and store the selected discrimination analysis models in the non-volatile memory 44 in step S40.

In this case, the CPU 41 inputs the prediction data to each discrimination analysis model stored in the non-volatile memory 44 in step S70 of the processing for predicting the order reception score illustrated in FIG. 12, and predicts the order reception score for each discrimination analysis model. Then, the CPU 41 combines the prediction results of the respective discrimination analysis models to predict a final order reception score for each company and for each company. For example, the order reception score for each discrimination analysis model may be weighted according to the discrimination analysis model, and a weighted average of each order reception score for a combination of the same company and the same commercial material may be used as a final order reception score.

Further, the CPU 41 may perform various shaping processing in order to display the predicted order reception score in an easily understandable manner in step S80 of the processing for predicting the order reception score illustrated in FIG. 12.

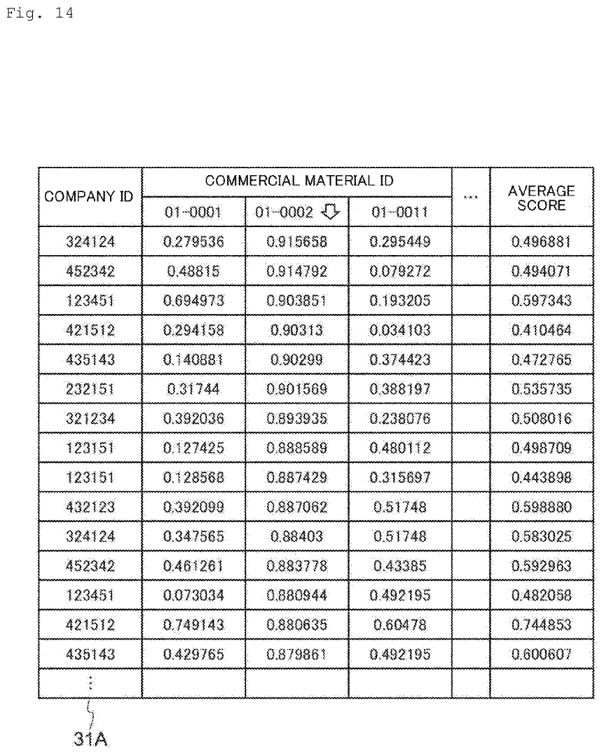

FIG. 14 is a diagram illustrating an example in which the predicted order acceptance score is displayed in a targeting list 31A. The targeting list 31A is a table in which order reception scores can be rearranged in descending order for each company and each commercial material, for example, for companies existing in an area of which the person in charge of business is in charge.

When the person in charge of business selects a commercial material ID column in which the commercial material ID of the targeting list 31A is displayed using a mouse or the like, the CPU 41 rearranges order reception scores for commercial materials corresponding to the selected commercial material ID in descending order and displays these on the display unit 49. In the example illustrated in FIG. 14, a commercial material ID column in which the commercial material ID is “01-0002” is selected.

When the person in charge of business selects a plurality of commercial material ID columns of the targeting list 31A, the CPU 41 may average the order reception scores of the respective commercial materials corresponding to the selected commercial material ID, and rearrange the company IDs in order from the higher average value of the order reception scores. Therefore, the person in charge of business can confirm the order reception score for a combination of the plurality of commercial materials. Naturally, the CPU 41 may rearrange the order reception scores in ascending order.

When the person in charge of business extracts the company having a high likelihood of purchasing the commercial material desired to be sold by himself or herself on the basis of the targeting list 31A, it is possible to prepare a visit plan of the company more quickly as compared with preparing the visit plan of the company by looking at a table in which order reception scores are arranged in disorder like the list 24A illustrated in FIG. 13.

Further, the CPU 41 may display a degree of contribution to the order reception score for each attribute of business information used for prediction of the order reception score. That is, the CPU 41 visualizes an influence of an attribute on the predicted order reception score together with a degree of influence.

For visualization of an attribute having a high degree of contribution to prediction of the order reception score and a distribution display indicating a degree of contribution of each attribute constituting the order reception score, a SHAP FIG. 32A or the like can be used. Alternatively, a model with high explanation performance is constructed more simply by performing learning with a small model using the output order reception score as correct answer data, and the degree of contribution of each attribute to the predicted order reception score may be visualized. A detailed influence of the attribute with high contribution can also be visualized for the order reception score for each company.

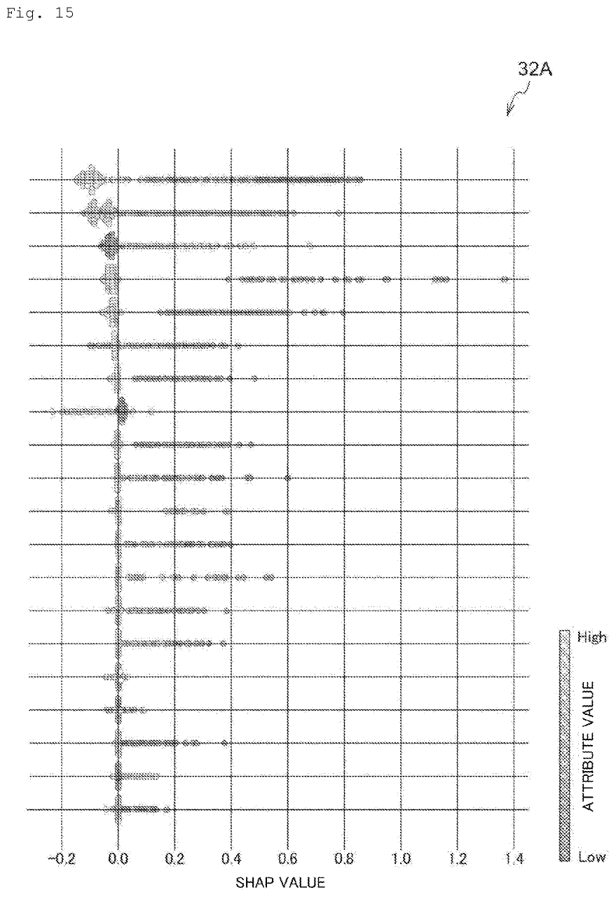

FIG. 15 is a diagram illustrating an example of the SHAP FIG. 32A. In the SHAP FIG. 32A, it is shown that situations of SHAP values of the respective attributes are arranged from up to down, and as the SHAP value is larger (that is, as it goes to the right along a horizontal axis), the degree of contribution of the attribute values plotted there is larger in a positive direction, and as the SHAP value is smaller (that is, as it goes to the left along the horizontal axis), the degree of contribution of the attribute value plotted there is larger in a negative direction. Further, a density of the SHAP FIG. 32A indicates a magnitude of the attribute value.

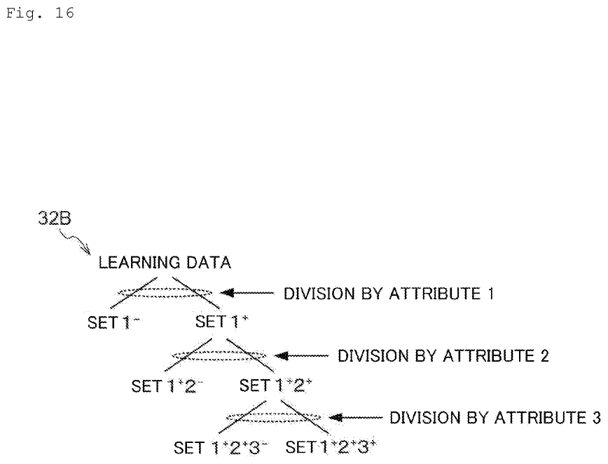

FIG. 16 illustrates an example of a small model using a single decision tree 32B. A correlation between the order reception score and the attribute is visualized by repeating processing for dividing a set of learning data used for prediction of the order reception score into two sets with the attribute value of the specific attribute as a boundary.

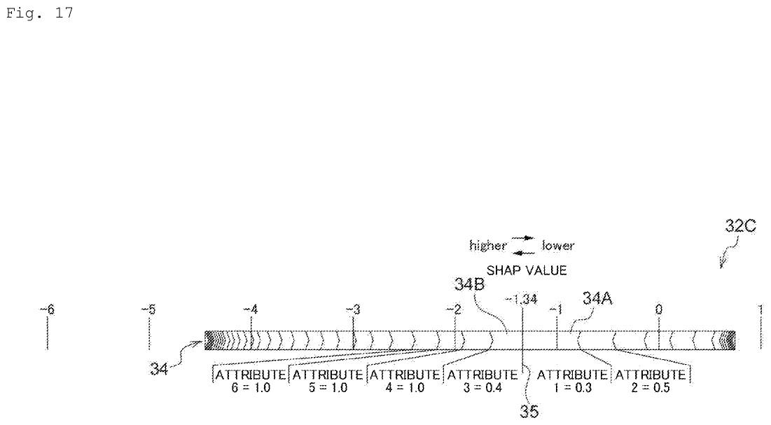

FIG. 17 is an example of a distribution diagram 32C showing the degree of contribution of each attribute to the predicted order reception score. In a graph 34, attributes associated with the graph 34 to the right of a reference line 35 (attribute 1 and attribute 2 in the example of FIG. 17) are attributes that contributed to a decrease in the order reception score, and attributes associated with the graph 34 to the left of the reference line 35 (attributes 3 to 6 in the example of FIG. 17) indicate attributes contributed to an increase in the order reception score. Further, in the graph 34, a length of a range of the graph 34 corresponding to each attribute indicates the degree of contribution. For example, a length of a range 34A represents a magnitude of the contribution of the attribute 1, and a length of the range 34B represents a magnitude of the contribution of the attribute 3.

Visualizing the degree of contribution of each attribute to the order reception score allows the person in charge of business to understand a background event by which the predicted order reception score is obtained, and to use the prediction result for business activity with more satisfaction. Further, because the attribute contributing to the order reception of each commercial material can be ascertained, the prediction result can be reflected on a business strategy, a product plan, and the like in each organization level such as a business team and the whole company.

Further, the CPU 41 may generate a company visit schedule on the basis of the targeting list 31A illustrated in FIG. 14. As described above, it is possible to rearrange companies having the likelihood of purchasing commercial materials for each commercial material in order from the higher order reception score by using the targeting list 31A. Therefore, the CPU 41 may extract a plurality of companies which can be visited in one day and whose order reception score is equal to or more than a reference value, for example, from address information of companies represented by the targeting list 31A and the company IDs of the targeting list 31A, and display a visit route.

The CPU 41 may extract a company located within a predetermined range from a place in which the person in charge of business exists from the specification information 11A on the basis of position information of an information device (for example, a smartphone) owned by the person in charge of business who has gone out, and display the position of the company located within a predetermined range and an order reception score of the company to overlap with a map 33A displayed on the information equipment owned by the person in charge of business.

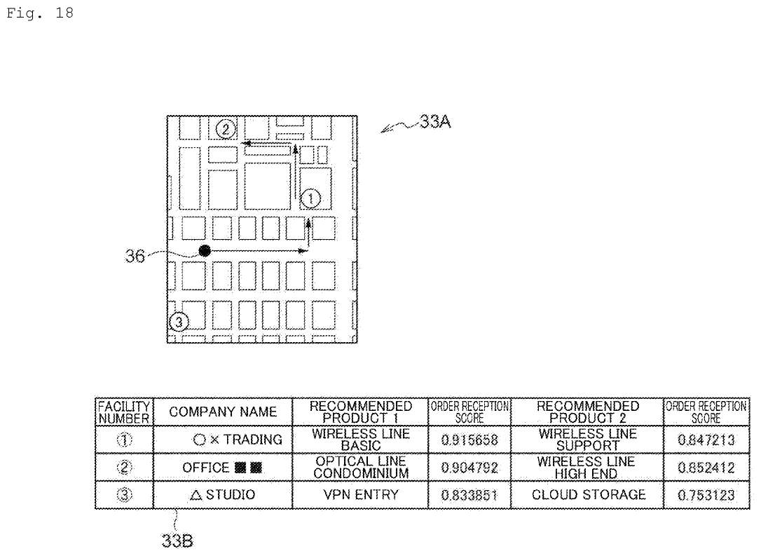

FIG. 18 is a diagram illustrating an example of the visit route displayed on the information device owned by the person in charge of business. In the map 33A, a point 36 represents a position of the person in charge of business, and the number represents a position of a company that is a visit destination. Further, the visit route from the person in charge of business to the company is displayed on the map 33A. In this case, the CPU 41 may display a visit table 33B showing recommended commercial materials for each company that is a visit destination. In the visit table 33B, the recommended commercial materials are selected in order from commercial materials having high order reception scores in the company that is a visit destination.

Thus, the CPU 41 performs shaping processing as illustrated in FIGS. 15 to 18 on the predicted order reception score, and notifies the person in charge of business of the predicted order reception score in an easily understandable manner.

### Second Embodiment

In the first embodiment, a form in which order reception/loss information, information on an area of a sales target, business type, and a company scale from a large number of past business information are used for prediction of the order reception score has been described. In the second embodiment, a form in which an order reception score of a new commercial material to which a similar commercial material is not present in the past is predicted will be described.

At the business site, new commercial materials are periodically charged and selling these becomes the responsibility of the person in charge of business. Hereinafter, a situation in which order reception/loss prediction of a new commercial material is performed in a situation in which business of a new commercial material is started and some order reception/loss results are obtained is assumed. It is very difficult to learn the order reception tendency from the order reception record of a few new commercial materials by using machine learning. That is, when an amount of learning data is small, a high-quality model cannot be obtained even when an existing machine learning scheme is used as it is. There are three methods as solutions to a case in which the amount of learning data is small.

(1) Transfer Learning

This is a technology for applying knowledge obtained from existing commercial materials to learning of new commercial materials. In the narrow sense, this is a learning scheme for projection from an existing commercial material distribution to a new commercial material distribution. In the present technology, when data regarding an existing commercial material is high in quality and has high relevance to a new commercial material that is a transfer destination, a high quality new commercial material model can be created. On the other hand, when the relevance is low, negative transition occurs, and the accuracy may be lowered.

(2) Fine Tuning

In particular, this is a scheme used in deep learning, and is a scheme for re-learning an output layer of a model learned by an existing commercial material with a new commercial material. That is, a weight of the entire model is re-learned by using a weight of the learned network as an initial value. On the basis of the degree of similarity between the collected data and a plurality of simulation results of an event occurring in the real world, the parameter is automatically and repeatedly corrected a correct parameter is estimated. However, because a model for basically performing deep learning includes a large number of parameters, a certain amount of data is required for re-learning of the output layer, and it is difficult to apply the model unless data sufficient for re-learning is obtained.

(3) Utilization of Domain Knowledge

This is a scheme for digitizing and utilizing know-how regarding a causal relationship of a matter of a person having expert knowledge. Domain knowledge has various viewpoints such as commercial material characteristics, business strategy, trend in the world, and analysis algorithm to be selected, and it is necessary to verify which one of these is focused to produce a highly accurate model.

(1) Transfer learning and (2) fine tuning of the related arts are schemes for making predictions from past order reception/loss record, but it is difficult to create an accurate model even when these are applied because the number of order reception/loss of new commercial materials is too small, and there is no order reception/loss of new commercial materials in simple extension of existing commercial materials due to different content or purpose of the commercial materials for each product.

Here, in general, it is rare to sell all handled products to customers at once, and basically, some products are selected and proposed for each customer. In this case, what kind of commercial material group that the person in charge of business selects and sells as a set is greatly influenced by the business strategy set for each head office, business division, and branch office. Further, this is greatly influenced by the existing contract situation of each customer.

Therefore, in the present embodiment, as the utilization of (3) domain knowledge of the related art, a degree of similarity of the commercial material is derived by paying attention to ease of selling the commercial material as a set (hereinafter referred to as sales tendency). A commercial material group categorized along a specific theme/keyword such as “an action reform” and “a paperless” in addition to the classification of commercial materials or a target is extracted for each keyword, and is used as an initial value of the degree of similarity of the commercial material. This is added as a feature quantity of machine learning together with other attributes, and a weight thereof is optimized through learning of actual data, so that only a keyword actually showing a tendency is reflected in learning.

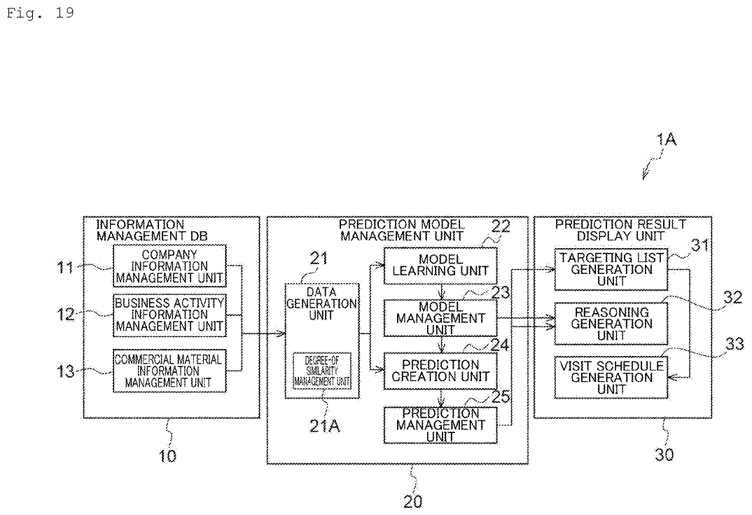

FIG. 19 is a diagram illustrating a functional configuration example of the business support device 1A according to the second embodiment The business support device 1A includes respective functional units of the information management DB 10, a prediction model management unit 20, and a prediction result display unit 30.

As illustrated in FIG. 19, the data generation unit 21 of the prediction model management unit 20 according to the present embodiment includes a degree-of-similarity management unit 21A that manages information on the degree of similarity of a way of sales and a way of purchase between commercial materials. Because the business support device 1A according to the present embodiment has the same configuration of the business support device 1 described in the first embodiment except that the degree-of-similarity management unit 21A is added, repeated description of overlapping portions is omitted.

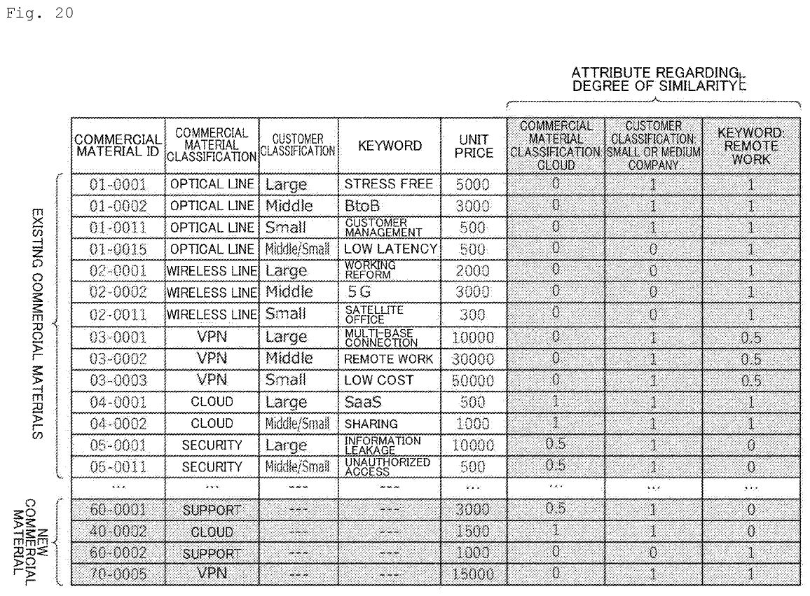

FIG. 20 illustrates an example of information managed by the degree-of-similarity management unit 21A. Here, for example, a commercial material ID for identifying a commercial material, a commercial material classification representing a category of the commercial material, a customer classification that is a sales target of the commercial material (for example, whether the commercial material is for large companies or small and middle companies), a keyword associated with the commercial material according to a specific business strategy such as “work style reform”, and “remote work”, a unit price of the commercial material, and an attribute regarding the degree of similarity are included for each commercial material. The degree of similarity is an index indicating a degree of similarity in the way of sales and the way of purchase between commercial materials. That is, the higher the degree of similarity between the commercial materials, the more the way of sales and the way of purchase are similar. The degree of similarity includes a degree of similarity between a new commercial material and an existing commercial material. An attribute related to the degree of similarity is an attribute related to the degree of similarity in the way of sales and the way of purchase between the commercial material. The attributes regarding the degree of similarity include, for example, “commercial material classification cloud”, “customer classification: small or middle company”, and “keyword: remote work”.

In the example of FIG. 20, commercial material IDs “01-0001” to “05-0011” are used as existing commercial materials, and commercial material IDs “60-0001” to “70-0005” are used as new commercial materials. The degree of similarity in the way of sales and the way of purchase is expressed as 1 (high), 0.5 (medium), and 0 (low) as an example in descending order of degree of similarity. That is, the degree of similarity “1” indicates that a commercial material is a he commercial material having a high degree of similarity in the way of sales and the way of purchase, the degree of similarity “0” indicates that a commercial material is a commercial material having a low degree of similarity in the way of sales and the way of purchase, and the degree of similarity “0.5” indicates that a commercial material is a commercial material having a medium degree of similarity in the way of sales and the way of purchase. The degree of similarity is set on the basis of hearing of persons in charge of business whose affiliation and Specialized field are different, for example, and an average value is used as a value of the degree of similarity. Specifically, it is shown that, for an existing commercial material with commercial material ID “01-0001”, the degree of similarity is “0” for a commercial material with the attribute of “commercial material classification: cloud”, the degree of similarity is “1” for a commercial material with the attribute of “customer classification: small and middle company”, and the degree of similarity is “1” for a commercial material with the attribute of “keyword: remote work”. Similarly, it is shown that, for a new commercial material with commercial material ID “60-0001”, the degree of similarity is “0.5” for a commercial material with the attribute of “commercial material classification: cloud”, the degree of similarity is “1” for a commercial material with the attribute of “customer classification: small and middle company”, and the degree of similarity is “0” for a commercial material with the attribute of “keyword: remote work”. The degree of similarity determined as described above is replaced with a category value representing the commercial material classification used in existing commercial material prediction, and the learning described with reference to FIGS. 7 and 8 is executed.

The data generation unit 21 manages the acquired similarity using the degree-of-similarity management unit 21A. The prediction creation unit 24 acquires the degree of similarity from the degree-of-similarity management unit 21A, and predicts the order reception score by including the acquired similarity in the data.

In the present embodiment, the quality of a data table illustrated in FIG. 20 is a decisive factor for prediction accuracy. It can be said that, in order to create a high-quality data table, it is desirable to utilize domain knowledge of at least one of a person in charge of business having a certain level or higher level of business skill, and a person in charge of business with specialized knowledge in a field related to commercial materials, rather than a person in charge of business having low overall business skill such as a new employee. Actually, it is possible to make accurate predictions by performing hearings from several persons in charge of business having specialized knowledge in the field related to commercial materials and acquiring domain knowledge, but it is desirable to perform hearings from as many persons in charge of business as possible. The “person in charge of business having a certain level or higher level of business skill” refers to, for example, a person in charge of business with high business skill, who has the number of years of business experience equal to or larger than a certain number of years, a sales record per unit period (for example, one year) equal to or larger than a certain amount, or the like. The “person in charge of business having specialized knowledge of a field related to a commercial material” is a person in charge of business familiar with the field related to the commercial material, and refers to, for example, a person in charge of business who has specialized knowledge in the field, such as having a qualification related to the field or the number of years of business experience in the field equal to or larger than a certain number.

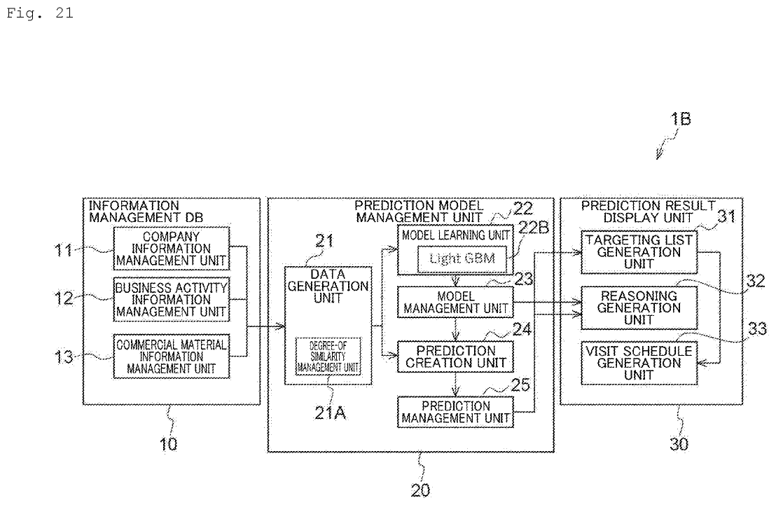

FIG. 21 is a diagram illustrating a configuration example of another business support device 1B according to the second embodiment. The business support device 1B includes respective functional units such as the information management DB 10, the prediction model management unit 20, and the prediction result display unit 30.

As illustrated in FIG. 21, the data generation unit 21 of the prediction model management unit 20 according to the present embodiment includes a degree-of-similarity management unit 21A, and the model learning unit 22 constructs LightGBM 22B which is one gradient boosting model learned by a combination of many decision trees.

The LightGBM 22B is one scheme for combining various conditions, and is an analysis algorithm capable of taking into analysis a relationship between a set sales or a past order reception history of the commercial materials (existing commercial materials). Here, machine learning of LightGBM 22B is performed by using the above-described similarity as one piece of learning data. The LightGBM 22B constructed by the model learning unit 22 is stored in the storage device by the model management unit 23. The prediction creation unit 24 predicts the order reception score by using the LightGBM 22B as a discrimination analysis model used for prediction of the order reception score.

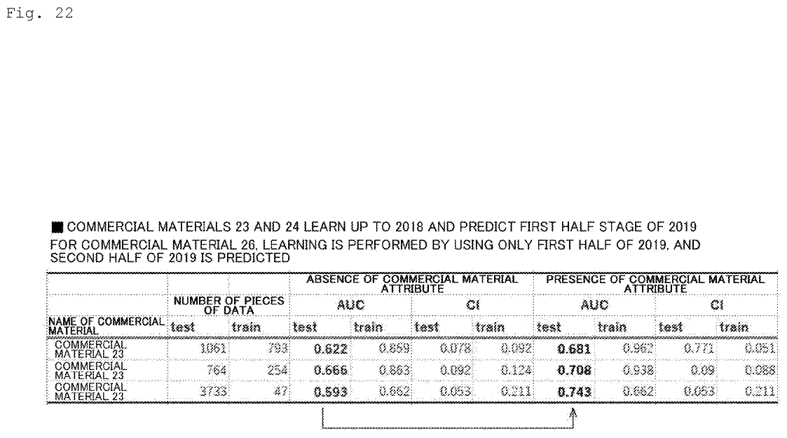

FIG. 22 is a diagram illustrating an example of evaluation results of learning and prediction using LightGBM 22B. In FIG. 22, learned LightGBM 22B is used to predict the order reception score for each product, an example of an evaluation result of evaluating a learning result and a prediction result for each of absence of commercial material attribute (absence of the degree of similarity) and presence of the commercial material attribute (presence of the degree of similarity) using the AUC is shown. Confidence Interval (CI) indicates a confidence interval and is an index value indicating the stability of the prediction result.

In the evaluation result illustrated in FIG. 22, “train” in the data number column represents the number of pieces of learning data used for learning, and “test” in the data number column represents the number of pieces of prediction data used for prediction. Further, “train” in an AUC column in the absence of the commercial material attribute represents an “AUC” for the learning data, and “test” in the “AUC” column represents an “AUC” for the prediction data. Further, “train” in a CI column of the absence of the commercial material attribute represents CI for the learning data, and “test” in the CI column represents a CI for the prediction data. Further, “train” in an AUC column with a commercial material attribute represents “AUC” for the learning data, and “test” in the “AUC” column represents an “AUC” for the prediction data. Further, “train” in the CI column with the commercial material attribute represents the CI for the learning data, and “test” in the CI column represents the CI for the prediction data.

In the example illustrated in FIG. 22, a “commercial material 23” and a “commercial material 24” are existing commercial materials, learning is performed by using data up to 2018, and the order reception score in a first half of 2019 is predicted. The “commercial material 26” is a new commercial material, learning is performed using only data in a first half of 2019, and the order reception score in a second half of 2019 is predicted.

When the prediction accuracy of the order reception score for each company of new commercial materials was evaluated by AUC, it was confirmed that AUC is “0.593” in a model in which the degree of similarity is not used, and AUC is “0.743” in a model in which a degree of similarity is used, for a commercial material 26. In the example illustrated in FIG. 22, because a ranking of each company of the ease of sale is important, a relative value of the score is important instead of an absolute value of the score, and the AUC is used as an evaluation scale.

According to the example illustrated in FIG. 22, it is understood that high prediction accuracy is realized especially in the commercial material 26 with less learning data by adopting model in which a degree of similarity is used.

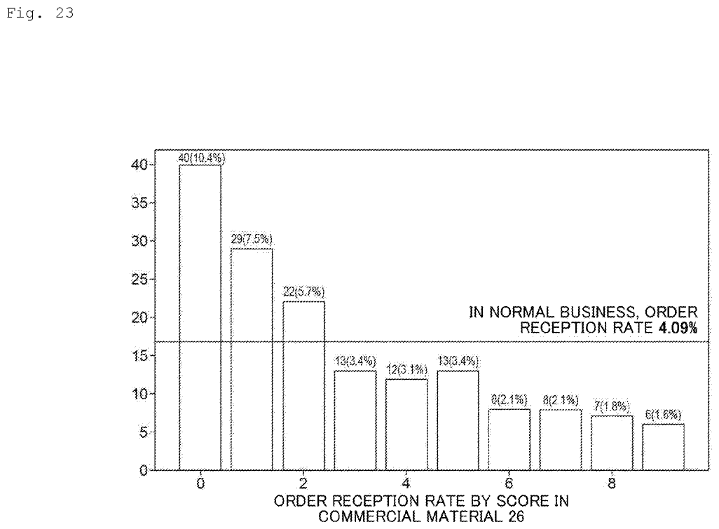

FIG. 23 is a graph illustrating an example of an order reception rate for each order reception score in the “commercial material 26”. According to the example of FIG. 23, it was confirmed that order reception of 10.4% that is double or more of the normal business was made in a group of companies with the top 10% of scores. However, in normal business, the order reception rate is 4.09%.

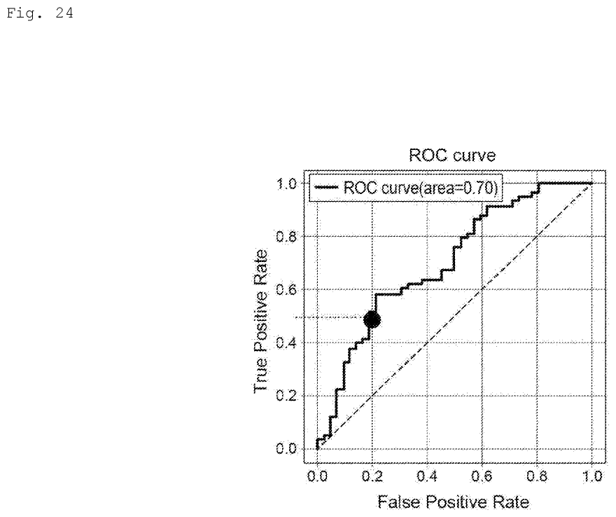

FIG. 24 is a graph illustrating an example of AUC. A receiver operating characteristic curve (ROC curve) illustrated in FIG. 24 is also called a guess curve, and is a plot of each of “True Positive Rate” on a vertical axis and “False Positive Rate” on a horizontal axis. The AUC is an area of a lower part of the ROC curve and, generally, the larger the area of the AUC, the better the machine learning performance. In this case, the higher the order reception rate with high scores, the higher the AUC (maximum 1). The example of FIG. 24 shows a case of AUC=0.7, and top 20% of scores include about 50% of positive examples.

According to the present embodiment, association with other commercial materials is performed using domain knowledge in order reception/loss prediction for new commercial materials that have little data and are not categorically similar to existing commercial materials, and various degrees of similarity between commercial materials are learned using teacher data of other commercial materials. In particular, a combination of LightGBM, which is one gradient boosting for learning by combining a large number of decision trees, with on-site business that are strongly influenced by set sales or existing commercial materials, allows prediction accuracy that can be used in practice to be realized even for new products that have substantially no order history or similar existing commercial materials. Further, domain knowledge necessary for a determination of the degree of similarity between commercial materials can be predicted with sufficient accuracy by hearing with a few persons in charge of business who have specialties, without having to hear from many persons in charge of business.

Various processors other than the CPU 41 may execute the business support processing executed by the CPU 41 reading the business support program in the embodiment. A dedicated electric circuit that is a processor having a circuit configuration designed exclusively for the purpose of execution of specific processing, such as a Programmable Logic Device (PLD) whose circuit configuration can be changed after a Field-Programmable Gate Array (FPGA) or the like is manufactured, an Application Specific Integrated Circuit (ASIC), or the like, for example, is illustrated as a processor in this case. Further, the business support processing may be executed by one of these various processors, or a combination of two or more processors of the same type or different types (for example, a plurality of FPGAs or a combination of a CPU and an FPGA). Further, a hardware-like structure of these various processors is, more specifically, an electric circuit in which circuit elements such as semiconductor elements are combined.

Further, in the embodiment, the embodiment in which the business support program is stored (also referred to as “installed”) in the ROM 42 or the non-volatile memory 44 in advance has been described, but the present invention is not limited thereto. The business support program may be provided in a form stored in a non-transitory storage medium such as a Compact Disk Read Only Memory (CD-ROM), a Digital Versatile Disk Ready Memory (DVD-ROM), and a Universal Serial Bus (USB) memory. Further, the business support program may be downloaded from an external device via a network.

All documents, patent applications, and technical standards described herein are incorporated herein by references to the same extent as a case in which incorporation of the individual reference documents, patent applications, and technical standards by references are described specifically and individually.

The following supplement is disclosed in relation to the embodiments described above.

(Supplement Item 1)

A business support device including a memory; and
at least one processor connected to the memory,
wherein the processor is configured to acquire business information including at least order reception/loss information relating to a business activity for each commercial material with respect to a company, which is a business target of a plurality of commercial materials configured of products or services, area information in which the company is located, a business type of the company, and a company scale of the company, and generate data used for prediction of an order reception score indicating an order reception likelihood for each company and each commercial material;
predict the order reception score for each company and for each commercial material by using the generated data; and
display the predicted order reception score.

(Supplement Item 2)

A non-transitory storage medium storing a program capable of being executed by a computer to execute business support processing, wherein the business support processing is configured to acquire business information including at least order reception/loss information relating to a business activity for each commercial material with respect to a company, which is a business target of a plurality of commercial materials configured of products or services, area information in which the company is located, a business type of the company, and a company scale of the company, and generate data used for prediction of an order reception score indicating an order reception likelihood for each company and each commercial material;
predict the order reception score for each company and for each commercial material by using the generated data; and
display the predicted order reception score.

1. A device comprising:
acquiring business information including at least order reception/loss information relating to business activity for each commercial material with respect to a company, which is a business target of a plurality of commercial materials configured of products or services, information on an area in which the company is located, a business type of the company, and a company scale of the company, and generate data used for prediction of an order reception score, wherein the order reception score indicates an order reception likelihood for each company and each commercial material;
predicting the order reception score for each company and for each commercial material by using the data; and
displaying the order reception score.

2. The device according to claim 1, wherein the predicting further comprises predicting the order reception score by combining prediction results in a plurality of discrimination analysis models used for prediction of the order reception score.

3. The device according to claim 1, wherein the predicting further comprises predicting the order reception score by using a discrimination analysis model having a prediction accuracy of the order reception score verified through cross verification among a plurality of discrimination analysis models used for prediction of the order reception score.

4. The device according to claim 2, wherein the predicting further comprises predicting the order reception score by using the discrimination analysis model updated for each predetermined period.

5. The device according to claim 1, wherein the acquiring further comprises acquiring a degree of similarity indicating a degree of similarity in the way of sales and the way of purchase between the commercial materials, and
the predicting further comprises predicting the order reception score by including the degree of similarity in the data.

6. The device according to claim 5, wherein the degree of similarity includes a degree of similarity between a new commercial material and an existing commercial material.

7. The device according to claim 5, wherein the degree of similarity is set on the basis of knowledge of at least one of a person in charge of business having a predetermined level of business skill or higher and a person in charge of business having specialized knowledge of a field related to commercial materials among persons in charge of business performing business activity.

8. The device according to claim 5, wherein the predicting further comprises predicting the order reception score by using a gradient boosting model learned by a combination of a plurality of decision trees as the discrimination analysis model used for prediction of the order reception score.

9. The device according to claim 1, wherein the displaying further comprises displaying prediction result display unit displays a degree of contribution to the order reception score for each attribute of the business information used for prediction of the order reception score.

10. A method comprising:
acquiring task information including at least order reception/loss information relating to task activity for each commercial material with respect to a company, which is a task target of a plurality of commercial materials configured of products or services, information on an area in which the company is located, a type of the company, and a company scale of the company, and generating data used for prediction of an order reception score, wherein the order reception score indicates an order reception likelihood for each company and each commercial material;
predicting the order reception score for each company and for each commercial material by using the generated data; and
displaying the predicted order reception score.

11. A computer-readable non-transitory recording medium storing computer-executable program instructions that when executed by a processor cause a computer system to execute a method comprising:
acquiring task information including at least order reception/loss information relating to task activity for each commercial material with respect to a company which is a task target of a plurality of commercial materials configured of products or services, information on an area in which the company is located, a type of the company, and a company scale of the company, and generating data used for prediction of an order reception score, wherein the order reception score indicates an order reception likelihood for each company and each commercial material;
predicting the order reception score for each company and for each commercial material by using the generated data; and
displaying the predicted order reception score.

12. The method according to claim 10, wherein the predicting further comprises predicting the order reception score by combining prediction results in a plurality of discrimination analysis models used for prediction of the order reception score.

13. The method according to claim 10, wherein the predicting further comprises predicting the order reception score by using a discrimination analysis model having a prediction accuracy of the order reception score verified through cross verification among a plurality of discrimination analysis models used for prediction of the order reception score.

14. The method according to claim 12, wherein the predicting further comprises predicting the order reception score by using the discrimination analysis model updated for each predetermined period.

15. The method according to claim 10, wherein the acquiring further comprises acquiring a degree of similarity indicating a degree of similarity in the way of sales and the way of purchase between the commercial materials, and
the predicting further comprises predicting the order reception score by including the degree of similarity in the data.

16. The method according to claim 15, wherein the degree of similarity includes a degree of similarity between a new commercial material and an existing commercial material.

17. The method according to claim 15, wherein the degree of similarity is set on the basis of knowledge of at least one of a person in charge of task having a predetermined level of task skill or higher and a person in charge of task having specialized knowledge of a field related to commercial materials among persons in charge of task performing task activity.

18. The computer-readable non-transitory recording medium according to claim 11, wherein the predicting further comprises predicting the order reception score by combining prediction results in a plurality of discrimination analysis models used for prediction of the order reception score.

19. The computer-readable non-transitory recording medium according to claim 11, wherein the predicting further comprises predicting the order reception score by using a discrimination analysis model having a prediction accuracy of the order reception score verified through cross verification among a plurality of discrimination analysis models used for prediction of the order reception score.

20. The computer-readable non-transitory recording medium according to claim 19, wherein the predicting further comprises predicting the order reception score by using the discrimination analysis model updated for each predetermined period.
